(19) United States
(12) Patent Application Publication
(10) Pub. No.: US 2008/0238320 A1
(43) Pub. Date: Oct. 2, 2008

(54) PLASMA DISPLAY PANEL AND METHOD OF MANUFACTURING THE SAME

(75) Inventor: TAE-JOUNG KWEON, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/966,091

(22) Filed: Dec. 28, 2007

(30) Foreign Application Priority Data
Mar. 28, 2007 (KR) 2007-30365

(51) Int. Cl. H01J 17/49; H01J 9/02

(52) U.S. Cl. 313/586; 445/24

(57) ABSTRACT

A plasma display panel (PDP) and a method of manufacturing the same are provided. The PDP includes a substrate; a dielectric layer formed on the substrate; and a barrier rib disposed to contact the dielectric layer, wherein the dielectric layer or the barrier rib comprises a first material or a second material according to a concentration gradient, the first material and the second material respectively having a low etching selectivity and a high etching selectivity with respect to a predetermined etching solution. According to the method, adhesive strength at the interface between the dielectric layer and the barrier rib can be improved.

### CROSS-REFERENCE TO RELATED APPLICATIONS

This application claims the benefit of Korean Application No. 2007-30365 filed Mar. 28, 2007, in the Korean Intellectual Property Office, the disclosure of which is incorporated herein by reference

### BACKGROUND OF THE INVENTION

1. Field of the Invention

Aspects of the present invention relate to a plasma display panel having an improved adhesion between a dielectric layer and a barrier rib, and a method of manufacturing the plasma display panel.

2. Description of the Related Art

Plasma display panels (PDP) generate vacuum (far) ultraviolet rays, from an inert gas, by applying a high-frequency voltage and irradiate fluorescent materials with the ultraviolet rays, to produce an image. PDPs are considered to be the next generation of large-scale, flat-panel display devices, due to excellent display properties, low weight, and thin structure.

PDPs include a dielectric layer and a barrier rib. The dielectric layer covers discharge electrodes, and the barrier rib is disposed close to the dielectric layer, to partition a plurality of discharge cells. In general, the dielectric layer and the barrier rib are formed of metal oxides. When the barrier rib is formed using a chemical etching method, the dielectric layer and the barrier rib should have different etching selectivities and thus, should have a different compositional ratios and/or constituents. More specifically, a barrier rib often includes metal oxides having a high etching selectivity, so that the barrier rib can be suitably etched by a predetermined etching solution, and the dielectric layer often includes metal oxides having a low etching selectivity. Therefore, due to the difference in properties between the barrier rib and the dielectric layer, the adhesion between the dielectric layer and the barrier rib may be reduced. Gas bubbles and/or voids may be generated during adhesion. In addition, the dielectric layer may be damaged and cell defects may occur, due to a reduction in the ability of the dielectric layer to withstand voltage.

FIGS. 1 and 2 are cross-sectional photographic images illustrating an interface between a dielectric layer and a barrier rib, of a conventional PDP. The dielectric layer and the barrier rib respectively contain Bi₂O₃, which can strongly resist a nitric acid solution, and ZnO, which can be dissolved by the nitric acid solution. Voids V are generated between the dielectric layer and the barrier rib, due to shrinkage differences between the dielectric layer and the barrier rib, during plasticization.

### SUMMARY OF THE INVENTION

Aspects of the present invention provide a plasma display panel having an improved adhesion between a barrier rib and a dielectric layer, so that the reliability of the plasma display panel is improved.

Aspects of the present invention also provide a method of manufacturing a plasma display panel having an improved adhesion between a barrier rib and a dielectric layer.

According to an aspect of the present invention, there is provided a plasma display panel (PDP) including: a substrate; a dielectric layer formed on the substrate; and a barrier rib disposed in contact with the dielectric layer. The dielectric layer or the barrier rib comprises a first material and a second material, with the relative concentrations of the first and second materials varying according to a gradient. The first material and the second material respectively have a low etching selectivity and a high etching selectivity. The etching selectivity relates to a predetermined etching solution.

The dielectric layer may include the first material as a major constituent The dielectric layer may include the first material in a concentration that gradually decreases in a direction toward the barrier rib. The dielectric layer may include the second material in a concentration that gradually increases in a direction toward the barrier rib.

The barrier rib may include the second material as a major constituent. Here, the barrier rib may include the second material in a concentration that gradually decreases in a direction toward the dielectric layer. The barrier rib may include the first material in a concentration that gradually increases in a direction toward the dielectric layer. The major constituent, as referred to herein, is the element present in the greatest amount in a compound.

The first material may include Bi₂O₃, PbO, or a combination thereof and have a low etching selectivity with respect to a nitric acid etching solution. The second material may include ZnO that has a high etching selectivity with respect to an etching solution.

Therefore, the dielectric layer and the barrier rib may include Bi₂O₃ or PbO, and ZnO, according to a concentration gradient. More specifically, the dielectric layer may include Bi₂O₃ or PbO in a concentration that gradually decreases in a direction toward the barrier rib, or ZnO in a concentration that gradually increases in a direction toward the barrier rib. In addition, the barrier rib may include Bi₂O₃ or PbO in a concentration that gradually increases in a direction toward the dielectric layer, or ZnO in a concentration that gradually decreases in a direction toward the dielectric layer.

According to another aspect of the present invention, there is provided a plasma display panel (PDP) including: a substrate; a dielectric layer formed on the substrate, including a first material having a low etching selectivity, with respect to a predetermined etching solution, as a major constituent; and a barrier rib disposed to contact the dielectric layer, including a second material, having a high etching selectivity, as a major constituent. The opposing surfaces of the dielectric layer and the barrier rib, an interface therebetween, can have roughened surfaces.

The first material can be Bi₂O₃ or PbO, materials that have a low etching selectivity with respect to a nitric acid etching solution. That is, the Bi₂O₃ and the PbO are not easily etched by the nitric acid etching solution. The second material can be ZnO, a material having a high etching selectivity with respect to the etching solution. The ZnO can be significantly dissolved by the etching solution.

According to another aspect of the present invention, there is provided a method of manufacturing a plasma display panel (POP) including: disposing a first paste layer, to form a dielectric layer, on a substrate; disposing a second paste layer, to form a barrier rib, on the first paste layer; drying the substrate; and plasticizing the substrate.

The drying may include performing a first drying process on the substrate and the first paste layer. After the first drying process is performed, the second paste layer may be disposed on the first paste layer. The drying may include performing a second drying process on the substrate including the second paste layer.

The first and second paste layers can be plasticized with a plasticizing agent. The plasticizing can occur after first and second layers are dried, or while the first and second paste layers are being dried. The drying and plasticizing process can be a single operation so that the PDP, according to aspects of the present invention, can be easily manufactured, and a poor adhesion between the dielectric layer and the barrier rib can be prevented.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1 and 2 are photographic images illustrating an interface between a dielectric layer and a barrier rib, included in a conventional plasma display panel (PDP);

FIG. 3 is an exploded perspective view of a plasma display panel, according to an exemplary embodiment of the present invention;

FIG. 4 is a cross-sectional view of the plasma display panel of FIG. 3 taken along a line IV-IV of FIG. 3;

FIG. 5 is a photographic image illustrating an interface between a barrier rib and a dielectric layer included in a plasma display panel, according to an exemplary embodiment of the present invention;

FIG. 6 is a graph illustrating a concentration gradient in the dielectric layer of FIG. 5;

FIGS. 7 and 8 are photographic images illustrating an interface between a barrier rib and a dielectric layer, included in a plasma display panel, according to another exemplary embodiment of the present invention;

FIG. 9 is a diagram of a method of manufacturing the plasma display panel of FIG. 5, according to an exemplary embodiment of the present invention; and

FIG. 10 is a diagram of a method of manufacturing the plasma display panel of FIG. 7, according to another exemplary embodiment of the present invention.

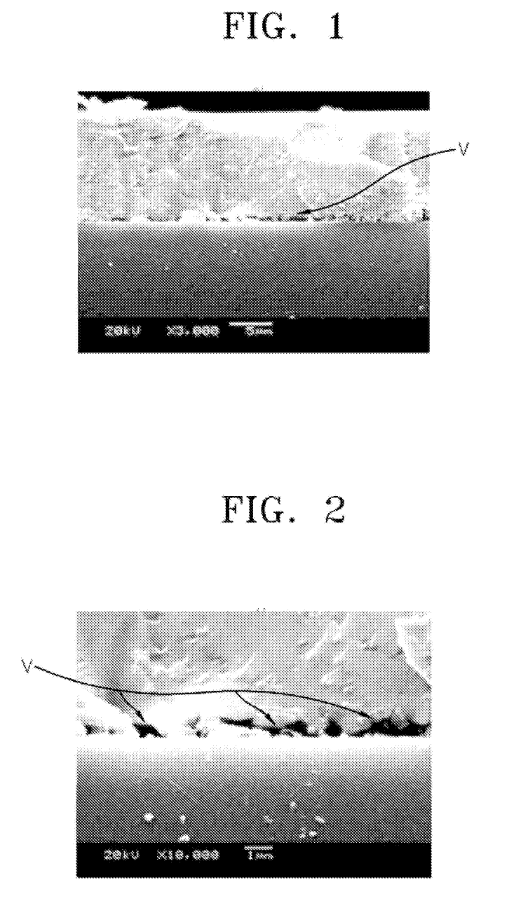

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

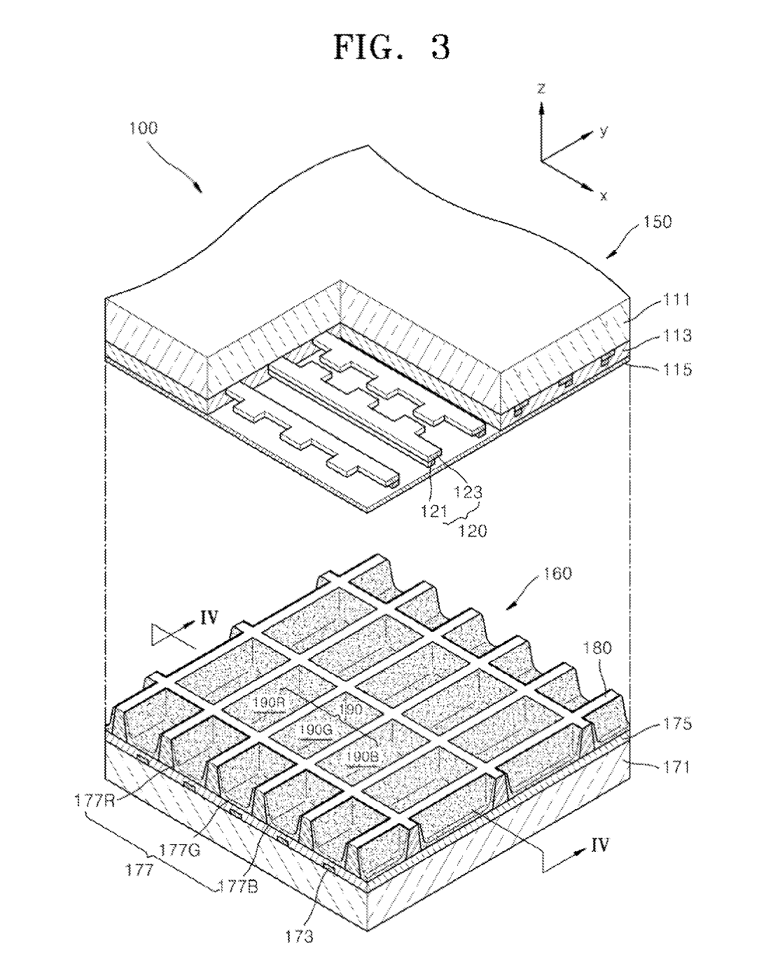

FIG. 3 is an exploded perspective view of a plasma display panel (PDP) 100, according to an exemplary embodiment of the present invention, and FIG. 4 is a cross-sectional view of the PDP taken along a line IV-IV of FIG. 3.

The PDP 100 includes an upper panel 150 and a lower panel 160.

The upper panel 150 includes a plurality of sustain discharge electrodes 120 that extend in an X-direction on a first substrate 111, and an upper dielectric layer 113 covering the sustain discharge electrodes 120. A protective layer 115 is disposed on the upper dielectric layer 113,

The first substrate 111 may be formed of a soda-lime glass having an excellent light permeability. In addition, the first substrate 111 may be colored in order to reduce the reflection of external light and to improve bright-room contrast.

The sustain discharge electrodes 120 are formed parallel to each other and extend in the X-direction on the first substrate 111. The sustain discharge electrodes 120 include X electrodes and Y electrodes facing each other. The X and Y electrodes respectively include a bus electrode 121 and a transparent electrode 123.

The bus electrode 121 compensates for the relatively large resistance of the transparent electrode 123, so that a nearly uniform voltage can be applied to a plurality of discharge cells 190. The bus electrode 121 may be formed of chrome (Cr), copper (Cu), or aluminum (Al).

Voltage is applied to the transparent electrode 123, to generate a sustained discharge in the discharge cells 190. The transparent electrode 123 may be formed of a material having a high visible light transmissivity and a low electrical resistance, for example, indium tin oxide.

In the upper dielectric layer 113, a discharge current is restricted, so as to sustain a glow discharge. Due to a wall charge accumulation, memory function and voltage are reduced. In order to increase discharge efficiency and withstand voltage, the visible light transmissivity may be high.

The protective layer 115 protects the upper dielectric layer 113 and the sustain discharge electrodes 120, from charged particle collisions, and increases the emission coefficient of secondary electrons, so that the voltage required to initiate discharge is reduced. The protective layer 115 may be formed of magnesium oxide (MgO).

The lower panel 160 includes a plurality of address electrodes 173 that extend in a Y-direction on a second substrate 171, and a lower dielectric layer 175 covering the address electrodes 173. Barrier ribs 180, used to form a plurality of the discharge cells 190, having rectangular cross-sections, are disposed on the lower dielectric layer 175. Phosphor layers 177 are disposed inside the discharge cells 190.

The second substrate 171 may be formed of a soda-lime glass having an excellent light permeability. The second substrate 171 may be colored, in order to reduce reflection of external light, and to improve bright-room contrast.

The address electrodes 173 are disposed parallel to each other and extend in the Y-direction, on the second substrate 171. The address electrodes 173 may be formed of chrome (Cr), copper (Cu), or aluminum (Al). A substantially uniform voltage can be applied to the plurality of discharge cells 190, as in the bus electrode 121.

The lower dielectric layer 175 protects the address electrodes 173 from collisions with charged particles. In the lower dielectric layer 175, discharge current is restricted so as to sustain a glow discharge. Due to a wall charge accumulation, memory function and voltage are reduced.

The barrier ribs 180 are formed on the lower dielectric layer 175. A partition discharge space is formed between the first substrate 111 and the second substrate 171, thereby forming space for the plurality of discharge cells 190. The barrier ribs 180 may have a matrix-type structure. However, the present invention is not limited thereto, and the barrier ribs 180 may be also formed so that the cross-sections of the discharge cells 190 can have a variety of different shapes, such as, circular shapes and polygonal shapes.

The barrier ribs 180 are formed to contact the lower dielectric layer 175. When the barrier ribs 180 are formed, using a chemical etching method, the lower dielectric layer 175 is used as an etching stopping membrane. The lower dielectric layer 175 and the barrier ribs 180, respectively contain materials having different etching selectivities.

The lower dielectric layer 175 comprises a first material having a low etching selectivity, as a major constituent, that is not significantly etched by an etching solution. The barrier ribs 180 comprise a second material having a relatively high etching selectivity, as a major constituent, that is significantly etched by an etching solution. For example, the lower dielectric layer 175 may comprise Bi₂O₃ or PbO and can have a low etching selectivity with respect to a nitric acid etching solution, as a first material. The barrier ribs 180 may comprise ZnO as a second material and can have a high etching selectivity with respect to an etching solution.

The lower dielectric layer 175 and the barrier ribs 180, contain major constituents according to a concentration gradient. More specifically, the lower dielectric layer 175 comprises a first material in a concentration that gradually decreases in a direction toward the barrier ribs 180. The barrier ribs 180 can comprise a second material in a concentration that gradually decreases in a direction toward the lower dielectric layer 175.

The lower dielectric layer 175 comprises a second material, as a minor constituent, and the barrier ribs 180 comprise a first material as a minor constituent. The lower dielectric layer 175 and the barrier ribs 180 contain their respective minor constituents according to concentration gradients. More specifically, the lower dielectric layer 175 comprises the second material in a concentration that gradually increases in a direction toward the barrier ribs 180. The barrier ribs 180 comprise the first material in a concentration that gradually increases in a direction toward the lower dielectric layer 175.

The lower dielectric layer 175 and the barrier ribs 180 comprise compositional constituents according to concentration gradients. At portions adjacent to the interface between the lower dielectric layer 175 and the barrier ribs 180, the difference in composition of the lower dielectric layer 175 and the barrier ribs 180 is minimized, thereby preventing a poor joining or adhesion therebetween.

The discharge cells 190 are formed by the barrier ribs 180, and the phosphor layers 177 are disposed in each of the discharge cells. In order to realize full-color displays, the phosphor layers 177 are various colors. For example, when a color image is realized, using the three primary colors of light, a red phosphor layer 177R, a green phosphor layer 1770, and a blue phosphor layer 177B are alternately coated in the discharge cells 190, thereby forming red discharge cells 190R, green discharge cells 190G, and blue discharge cells 190B. A discharge gas is injected into the discharge cells. The discharge gas may be an inert gas, such as, neon (Ne), xenon (Xe), helium, or a mixture thereof.

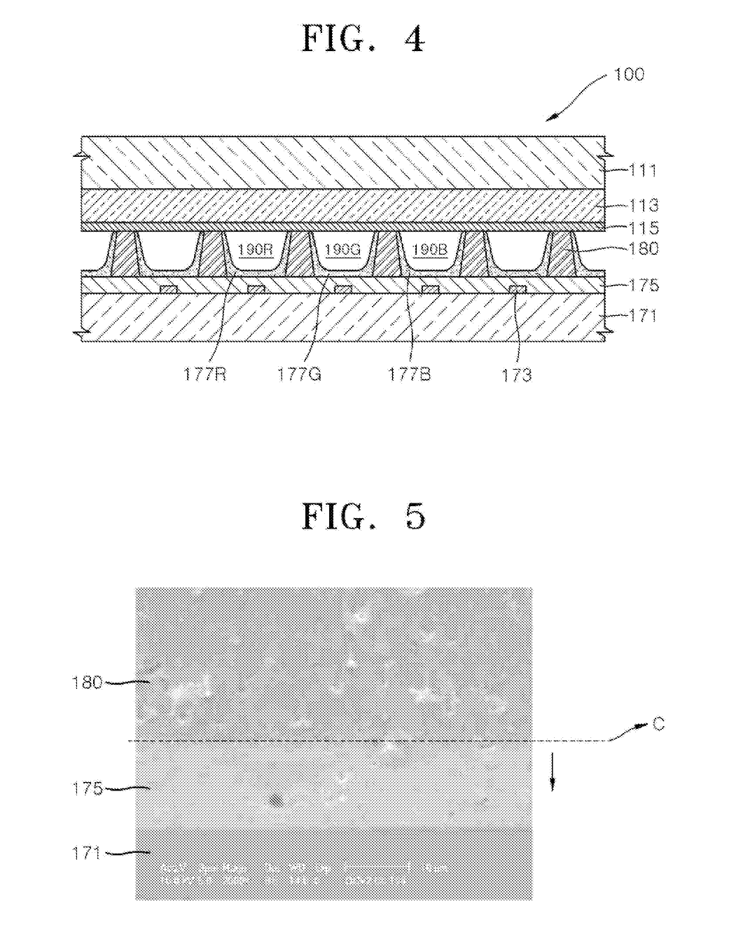

FIG. 5 is a photographic image illustrating a cross-sectional view of a portion of a PDP, similar to the PDP 100 of FIG. 3, in which a lower dielectric layer 175, comprising PbO and ZnO, is formed on a second substrate 171, according to a concentration gradient. The barrier ribs 180 are formed on the lower dielectric layer 175.

The lower dielectric layer 175 comprises PbO as a major constituent. The lower dielectric layer 175 comprises a higher concentration of PbO, at the interface C between the lower dielectric layer 175 and the barrier ribs 180. The concentration of PbO, in the lower dielectric layer 175, increases in a direction ↓ that extends away from the interface C. The lower dielectric layer 175 comprises a concentration of ZnO that decreases in the direction ↓ away from the interface C. In other words, the lower dielectric layer 175 comprises a higher concentration of ZnO and a lower concentration of PbO, at the interface C than at an interface with the second substrate 171.

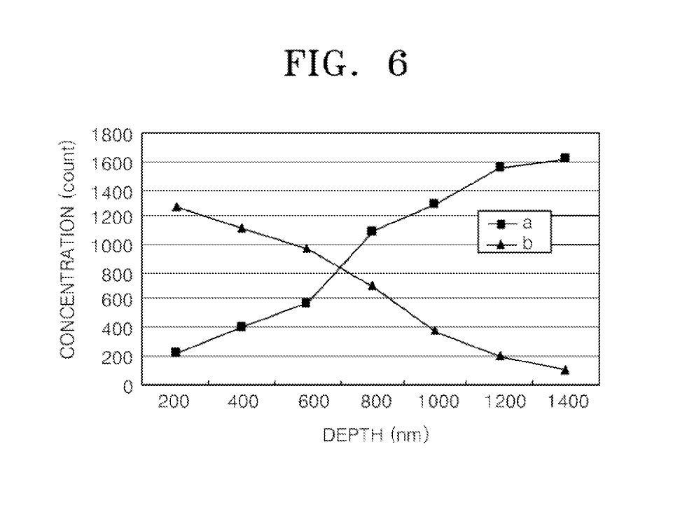

FIG. 6 and Table 1 illustrate the results obtained by analyzing the concentration of Pb(a) and Zn(b), in the lower dielectric layer 175, in a direction away from the interface C, between the barrier ribs 180 and the lower dielectric layer 175. The results were measured by moving 200 nm, in the lower dielectric layer 175, in the direction away from the interface C. The concentration is a measurement of an amount of an element detected per unit time, and the unit used here is “count.”

At the interface C, the concentration of ZnO is greater than the concentration of PbO. The portion of the lower dielectric layer 175, disposed close to the interface C, has properties similar to the barrier ribs 180 comprising ZnO as a major constituent. Thus adhesive strength between the lower dielectric layer 175 and the barrier ribs 180 can be increased.

TABLE1

| DEPTH (nm) | Pb (count) | Zn (count) |
|---|---|---|
| 200 | 213 | 1283 |
| 400 | 411 | 1124 |
| 600 | 575 | 981 |
| 800 | 1101 | 702 |
| 1000 | 1302 | 387 |
| 1200 | 1560 | 198 |
| 1400 | 1621 | 102 |

In an exemplary embodiment of the present invention, the concentration gradient, of the compositional constituents of the lower dielectric layer 175, is identified. However, the present teachings are not limited thereto. The barrier ribs 180 may comprise ZnO as a major constituent, in a concentration that gradually decreases in a direction toward the lower dielectric layer 175. The barrier ribs 180 can comprise a minor constituent PbO in a concentration that gradually increases in the direction toward the lower dielectric layer 175. Both of the lower dielectric layer 175, and the barrier ribs 180 can comprise compositional constituents according to a concentration gradient.

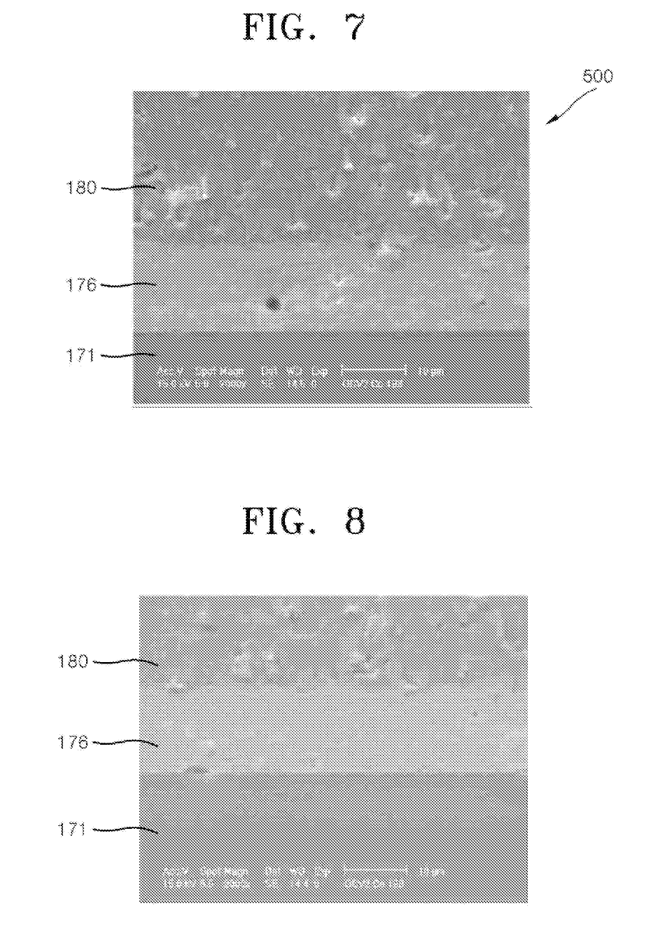

FIGS. 7 and 8 are photographic images illustrating an interface between a barrier rib 181 and a lower dielectric layer 176 included in a PDP 500, according to an exemplary embodiment of the present invention. The lower dielectric layer 176 is disposed on a second substrate 171 and the barrier rib 181 is disposed on the lower dielectric layer 176. The lower dielectric layer 176 and the barrier rib 181, each comprise PbO and ZnO. The lower dielectric layer 176 comprises PbO as a major constituent and has a low etching selectivity with respect to a nitric acid etching solution. The barrier rib 181 comprises ZnO as a major constituent and has a high etching selectivity. Bi₂O₃ may be used instead of, or in combination with, PbO, for example.

Although the barrier rib 181 and the lower dielectric layer 176 each have a different major constituent, the interface between the lower dielectric layer 176 and the barrier rib 181 is formed to have a surface roughness, or a predetermined roughness, and thus the contact area between the lower dielectric layer 176 and the barrier rib 181 increases, thereby strengthening the adhesion therebetween.

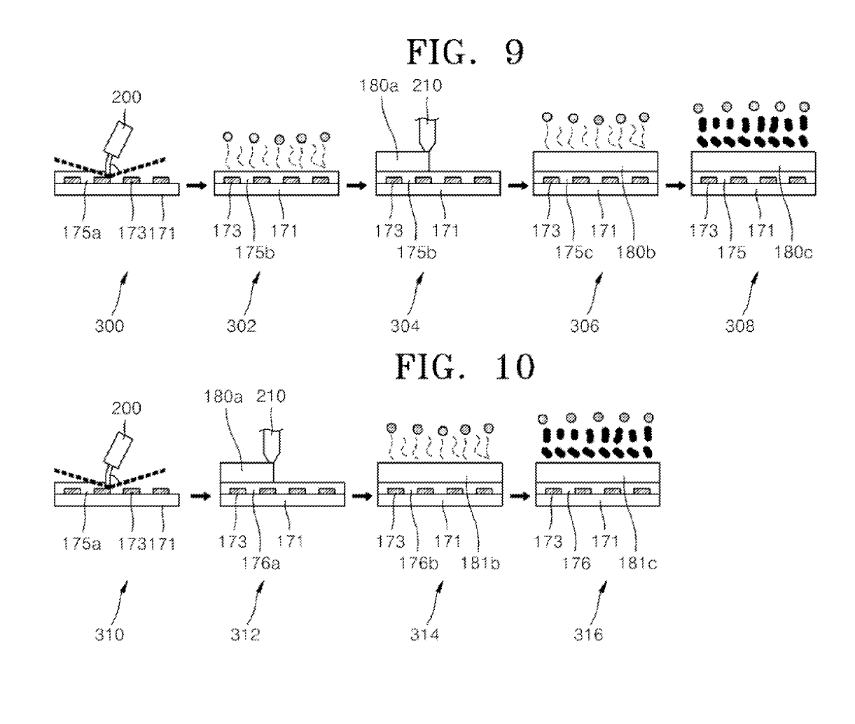

FIG. 9 is a diagram of a method of manufacturing the PDP 100 of FIG. 5, according to an exemplary embodiment of the present invention. More specifically, a method of manufacturing the lower dielectric layer 175 and the barrier ribs 180 of FIG. 5, according to concentration gradient will now be described.

In operation 300, a first paste layer 175a is uniformly printed, or coated, on the second substrate 171. The first paste layer 175a can be become the lower dielectric layer 175, A screen printing apparatus 200 is used to form the first paste layer 175a on the second substrate 171. The first paste layer 175a contains a first material and a second material, which have different etching selectivities with respect to an etching solution. However, a major constituent of the first paste layer 175a is a first material having a low etching selectivity. For example, the first paste layer 175a may comprise PbO, which has a low etchability with respect to a nitric acid etching solution.

In operation 302, a first drying process is performed on the second substrate 171 and the first paste layer 175a, to form a dried first paste layer 175b. The dried first paste layer 175b can be a porous membrane that is not densified like a plastic membrane.

In operation 304 a coating unit 210 is used to coat a second paste layer 180a on the dried first paste layer 175b. The second paste layer 180a can be become the barrier ribs 180. The second paste layer 180a is coated onto the dried first paste layer 175b. However, the present invention is not limited thereto, and the second paste layer 180a can be deposited by printing or another suitable process. The second paste layer 180a comprises a first material and a second material. However, a major constituent of the second paste layer 180a is the second material, which has a high etching selectivity. For example, the second paste layer 180a may comprise ZnO, which has a high etching selectivity with respect to a nitric acid etching solution.

When the second paste layer 180a is coated on the dried first paste layer 175b, the second paste layer 180a penetrates the pores of the first paste layer 175b. Accordingly, ZnO penetrates the first paste layer 175b and forms a concentration gradient. More specifically, the dried first paste layer 175b comprises a concentration of ZnO that gradually decreases in a direction toward the dried first paste layer 175b. In addition, since the ZnO penetrates the dried first paste layer 175b, the dried first paste layer 175b comprises a concentration of ZnO that gradually increases toward the first paste layer 175b, in a direction away from the interface between the first paste layer 175b and the second paste layer 180a.

In operation 306, a second drying process is performed on the second substrate 171, the dried first paste layer 175b, and/or the second paste layer 180a. Operation 306 can include plasticizing the dried first paste layer 175b and the second paste layer 180, to form a plasticized first paste layer 175c and a plasticized second paste layer 180b.

In operation 308, the plasticized second paste layer 180b is etched, using a chemical etching method, to form the ribs 180 and to expose the plasticized first paste layer 175c, thereby forming the lower dielectric layer 175. The etching shapes the ribs into a matrix. Here, the lower dielectric layer 175 comprises a first material having a lower etching selectivity than the ribs 180, as a major constituent. The lower dielectric layer 175 resists the etching, and thus, the lower dielectric layer 175 can be used as an etching stopping membrane.

The lower dielectric layer 175 comprises a compositional constituent, in a concentration that varies according to a gradient. However, the present invention is not limited thereto. The barrier ribs 180 also can be designed to comprise a compositional constituent according to a concentration gradient. After the second paste layer 180a is formed on the dried first paste layer 175b, and the second substrate 171 is turned over, the ZnO, which is a major constituent of the second paste layer 180a, penetrates the first paste layer 175b.

FIG. 10 is a diagram for explaining a method of manufacturing the PDP of FIG. 7, according to another embodiment of the present invention. More specifically, FIG. 10 is a diagram for explaining a method of manufacturing the PDP in which a surface roughness is formed at the interface of the lower dielectric layer 175 and the barrier rib 180. The method of manufacturing the PDP of FIG. 7 is similar to that of FIG. 9, except that operation 302 is excluded. Hereinafter, mainly the differences will be described.

In operation 310, the first paste layer 176a is formed on the second substrate 171 and is not dried. In operation 312 the second paste layer 180a is directly deposited on the first paste layer 176a. The first paste layer 176a can be allowed to become semi-solid, before the second paste layer 181a is deposited on the first paste layer 176a.

In operation 314, the first paste layer 176a and the second paste layer 181a are dried and plasticized at the same time, to form a plasticized first paste layer 176b and a plasticized second paste layer 180b. The interface between plasticized first paste layer 176b and the plasticized second paste layer 181b can be formed to have a surface roughness. Therefore, the contact area between the lower dielectric layer 175 and the plasticized second paste layer 181b is increased, and the adhesive strength, of a bond therebetween, is increased.

In operation 316, the plasticized second paste layer 181b is etched, using a chemical etching method, as in FIG. 9, and thus, the manufacture of the matrix-type barrier rib 181 is completed.

As described above, in the aspects of the present invention, each of a dielectric layer and a barrier rib disposed to contact the dielectric layer, comprise a first material and a second material, wherein the first and second materials have different etching selectivities, according to concentration gradient of the first and second materials. The difference in concentration between the first material and the second material is reduced at the interface between the dielectric layer and the barrier rib, thereby improving the adhesive strength of a bond between the dielectric layer and the barrier rib. In addition, since the interface between the dielectric layer and the barrier rib is formed to have a surface roughness, the contact surface is increased, and thus, the adhesive strength of the bond is improved. Therefore, since adhesive strength between the dielectric layer and the barrier rib is increased, the dielectric layer can be prevented from being damaged, cell defects can be prevented due to void formation, and voltage tolerance can be maintained. Thus, a PDP having improved reliability can be provided.

Moreover, a drying process can be omitted, so that a PDP can be easily manufactured. The dielectric layer and the barrier rib included therein can comprise a first material and a second material according to a concentration gradient Also, a drying and plasticizing process can be omitted, so that the PDP can be easily manufactured with the interface of the dielectric layer and the barrier rib having a surface roughness.

Although a few embodiments of the present invention have been shown and described, it would be appreciated by those skilled in the art that changes may be made in this embodiment without departing from the principles and spirit of the invention, the scope of which is defined in the claims and their equivalents. As used herein, the phrase “at least one” refers to a single component or multiple components following the phrase.

What is claimed is:

1. A plasma display panel (PDP) comprising:
a substrate;
a dielectric layer disposed on the substrate; and
a barrier rib disposed on the dielectric layer,
wherein at least one of the dielectric layer and the barrier rib comprises concentrations of a first material a second material, the relative concentrations of the first and second materials vary according to a gradient, the first material has a low etching selectivity and the second material has a high etching selectivity with respect to an etching solution.

2. The PDP of claim 1, wherein the dielectric layer comprises more of the first material than the second material.

3. The PDP of claim 1, wherein the barrier rib comprises more of the second material than the first material.

4. The PDP of claim 1, wherein the concentration of the first material in the dielectric layer decreases in a direction toward the barrier rib.

5. The PDP of claim 1, wherein the concentration of the second material in the dielectric layer increases in a direction toward the barrier rib.

6. The PDP of claim 1, wherein the concentration of the first material in the barrier rib increases in a direction toward the dielectric layer.

7. The POP of claim 1, wherein the concentration of the second material in the barrier rib decreases in a direction toward the dielectric layer.

8. The PDP of claim 1 wherein the first material comprises at least one of Bi₂O₃ and PbO and the second material comprises ZnO.

9. The PDP of claim 8, wherein the concentration of the ZnO in the dielectric layer increases in a direction toward the barrier rib.

10. The PDP of claim 8, wherein the concentration of the at least one of the Bi₂O₃ and the PbO in the dielectric layer decreases in a direction toward the barrier rib.

11. The PDP of claim 8, wherein the concentration of the ZnO in the barrier rib decreases in a direction toward the dielectric layer.

12. The PDP of claim 8, wherein the concentration of the at least one of the Bi₂O₃ and the PbO in the barrier rib increases in a direction toward the dielectric layer.

13. A plasma display panel (PDP) comprising:
a substrate;
a dielectric layer disposed on the substrate, and comprising a first material having a low etching selectivity with respect to an etching solution as a major constituent; and
a barrier rib disposed on the dielectric layer, and comprising a second material having a high etching selectivity with respect to the etching solution as a major constituent,
wherein the dielectric layer has a roughened surface, the barrier rib has a roughened surface, and the roughened surface of the dielectric layer contacts the roughened surface of the barrier rib.

14. The PDP of claim 13, wherein the first material comprises at least one of Bi₂O₃ and PbO.

15. The PDP of claim 13, wherein the second material comprises ZnO.

16. A method of manufacturing a plasma display panel (PDP) comprising:
disposing a first paste layer to form a dielectric layer, on the substrate;
disposing a second paste layer to form a barrier rib, on the first paste layer;
drying the first and second paste layers; and
plasticizing the first and second paste layers.

17. The method of claim 16, further comprising drying the first paste layer before the disposing of the second paste layer.

18. The method of claim 17, wherein the drying of the first paste layer comprises forming a dried first paste layer, and the disposing of the second paste layer comprises disposing the second paste layer on the dried first paste layer.

19. The method of claim 16, wherein the second paste layer comprises ZnO and the disposing of the second paste layer comprises having the ZnO penetrate into the first paste layer.

20. The method of claim 16, further comprising etching the second paste layer to form one or more barrier ribs.

21. The method of claim 16, wherein the drying and the plasticizing operations are conducted at the same time.

22. The PDP of claim 1, wherein:
the barrier rib and the dielectric layer contact one another at an interface; and
the concentrations of the first and second materials in the barrier rib and the dielectric layer are approximately equal at the interface.

23. The PDP of claim 1, wherein the etching solution comprises nitric acid.

24. A plasma display panel (PDP) comprising:
a substrate;
a dielectric layer disposed on the substrate, having a first surface and a second surface, and comprising a first material and a second material,
wherein the concentration of the first material relative to the second material varies from the first surface to the second surface according to a first concentration gradient; and
a barrier rib having a first surface and a second surface disposed in contact with the first surface of the dielectric layer, and comprising the first material and the second material,
wherein the concentration of the first material relative to the second material varies from the first surface to the second surface according to a second concentration gradient.

25. The PDP of claim 24, wherein the concentrations of the first and second materials at the second surface of the barrier rib are approximately equal to the concentration of the first and second materials at the first surface of the dielectric layer.

26. The PDP of claim 24, wherein:
the first material has a first etching selectivity for an etching solution;
the second material has a second etching selectivity to the etching solution; and
the first etching selectivity is lower than the second etching selectivity.

27. The PDP of claim 24, wherein the first material comprises one of Bi₂O₃ and PbO.

28. The PDP of claim 24, wherein the second material comprises ZnO.

29. The PDP of claim 24, wherein the first concentration gradient and the second concentration gradient are approximately equal.
